(19) United States
(12) Patent Application Publication
(10) Pub. No.: US 2024/0343069 A1
(43) Pub. Date: Oct. 17, 2024

(54) TIRE

(71) Applicant: Sumitomo Rubber Industries, Ltd., Kobe-shi (JP)

(72) Inventors: Kenta Yagi, Kobe-shi (JP); Shunya ARAKI, Kobe-shi (JP)

(73) Assignee: Sumitomo Rubber Industries, Ltd., Kobe-shi (JP)

(21) Appl. No.: 18/613,298

(22) Filed: Mar. 22, 2024

(30) Foreign Application Priority Data
Apr. 14, 2023 (JP) 2023-066327

(51) Int. Cl. B60C 11/03; B60C 11/12

(52) U.S. Cl. CPC B60C 11/0304; B60C 11/0302; B60C 11/0306; B60C 11/1204; B60C 11/1236; B60C 11/1259; B60C 11/1281; B60C 2011/1213

(57) ABSTRACT

A tire has a tread portion including a block row including a plurality of blocks separated by a plurality of axial grooves. Each of the blocks is provided with one circumferential sipe extending in the tire circumferential direction so as to communicate with at least one of the axial grooves. The circumferential sipe includes at least one bent portion bent locally. At least one of edges of the circumferential sipe is provided with a chamfered portion.

### RELATED APPLICATIONS

This application claims the benefit of foreign priority to Japanese Patent Application No. JP2023-066327, filed Apr. 14, 2023, which is incorporated by reference in their entirety.

### FIELD OF THE INVENTION

The present disclosure relates to a tire.

### BACKGROUND OF THE INVENTION

Japanese Unexamined Patent Application Publication No. 2012-218651 has proposed a pneumatic tire having an improved on-ice/on-snow performance for passenger cars. In this pneumatic tire, a groove width, a shape, and arrangement of each of main grooves extending in the tire circumferential direction and axial grooves formed in a tread portion are specified to improve the on-ice/on-snow performance while suppressing deterioration of drainage performance and noise performance.

### SUMMARY OF THE INVENTION

In recent years, a variety of all-season tires (also referred to as all-weather tires) capable of running on showy road surfaces in addition to dry and wet road surfaces have been proposed. In this type of tire, if the blocks are provided with sub-grooves or sipes extending in the tire circumferential direction in order to improve running performance on snowy road surfaces, steering stability on dry road surfaces may be impaired.

The present disclosure was made in view of the above, and a primary object thereof is to provide a tire capable of improving the running performance on snowy road surfaces while maintaining the steering stability on dry road surfaces.

The present disclosure is a tire having a tread portion including a plurality of axial grooves, a plurality of blocks separated by the plurality of axial grooves, and a block row including the plurality of blocks, wherein each of the blocks is provided with one circumferential sipe, the circumferential sipe extends in the tire circumferential direction so as to communicate with at least one of the axial grooves and has one or more bent portions bent locally, and at least one of edges of the circumferential sipe is provided with a chamfered portion.

By adopting the configuration described above, the tire of the present disclosure can improve the running performance on snowy road surfaces while maintaining the steering stability on dry road surfaces.

### BRIEF DESCRIPTION OF THE DRAWINGS

FIG. 1 is a development view of a tread portion according to an embodiment of the present disclosure.

FIG. 2 is an enlarged view of a first middle land region.

FIG. 3 is an enlarged view of two first middle blocks.

FIG. 4 is a cross-sectional view taken along C-C line in FIG. 3.

FIG. 5 is an enlarged cross-sectional view of a circumferential sipe according to another embodiment.

FIG. 6 is a reference diagram showing enlarged cross-sectional views of a first shoulder circumferential groove and a first middle axial groove arranged side by side.

FIG. 7 is an enlarged view of a second shoulder circumferential groove and a second crown circumferential groove of FIG. 1.

FIG. 8 is a cross-sectional view taken along A-A line in FIG. 7.

FIG. 9 is a cross-sectional view taken along B-B line in FIG. 7.

FIG. 10 is an enlarged view of a second middle land region and a crown land region of FIG. 1.

FIG. 11 is a cross-sectional view taken along D-D line in FIG. 10.

FIG. 12 is a cross-sectional view of a tapered portion of one of crown blocks according to another embodiment.

FIG. 13 is an enlarged view of a first shoulder land region of FIG. 1.

FIG. 14 is a development view of the tread portion of a tire in Reference.

### DETAILED DESCRIPTION OF THE INVENTION

An embodiment of the present disclosure will now be described in conjunction with accompanying drawings.

The drawings contain exaggerated representations and representations that differ from the actual dimensional ratios of the structure in order to aid in the understanding of the present disclosure. Further, in cases where there are multiple embodiments, the identical or common elements are denoted by the same reference numerals throughout the specification, and redundant explanations will be omitted.

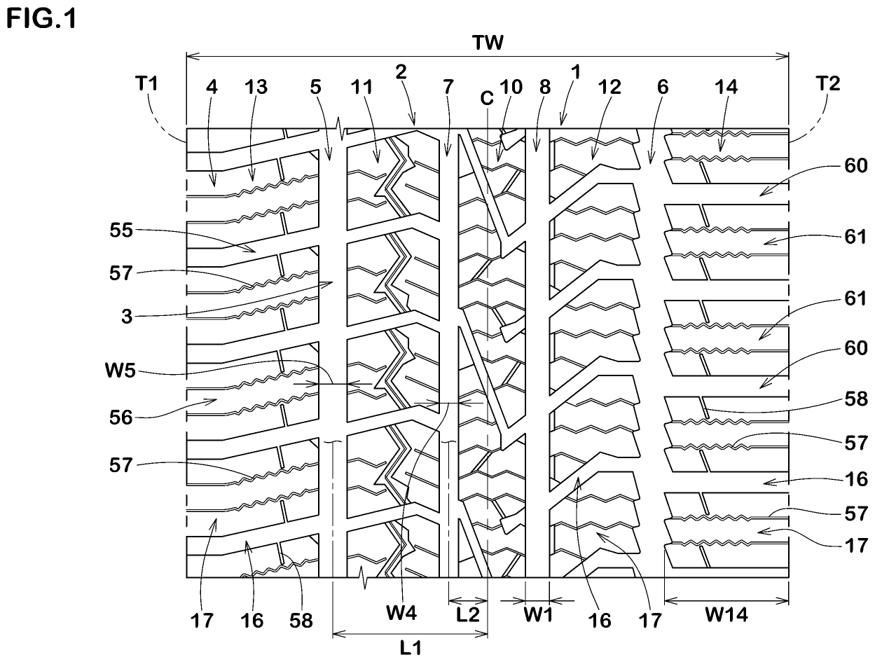

As shown in FIG. 1, a tread portion 2 of the present disclosure includes a first tread edge T1, a second tread edge T2, a plurality of circumferential grooves 3 extending continuously in the tire circumferential direction between the first tread edge T1 and the second tread edge T2, and a plurality of land regions 4 demarcated by these circumferential grooves 3. In a preferred embodiment, a tire 1 of the present embodiment has the tread portion 2 provided with four circumferential grooves 3 and five land regions 4. Further, in the present embodiment, each of the land regions 4 is configured as a block row containing a plurality of blocks 17 divided or demarcated by a plurality of axial grooves 16. However, the present disclosure is not limited to such a manner.

The tread portion in the present embodiment has the tread portion position for mounting the tire on a vehicle is specified regarding inner and outer sides of the tread portion with respect to the vehicle. Thereby, the first tread edge T1 is intended to be located on the outer side of the vehicle when the tire 1 is mounted on the vehicle. The second tread edge T2 is intended to be located on the inner side of the vehicle when the tire 1 is mounted on the vehicle. The position or direction of mounting the tire on the vehicle is indicated by letters or symbols on a sidewall portion (not shown), for example. However, the tire 1 of the present disclosure is not limited to such a mode, and may be one in which the position of mounting on the vehicle is not specified, or one in which the first tread edge T1 is located on the inner side of the vehicle when mounted on the vehicle.

The first tread edge T1 and the second tread edge T2 correspond to axially outermost edges of the ground contact surface of the tire 1 in a standard state loaded with 70% of a standard tire load, and in contact with a flat surface with zero camber angle.

The term “standard state” refers to a state in which the tire is mounted on a standard rim, inflated to a standard inner pressure, and loaded with no tire load in the case of tires for which various standards have been established. In the case of tires for which various standards have not been established or non-pneumatic tires, the standard state means a standard usage state according to the purpose of use of the tire and not being mounted on a tire rim (for non-pneumatic tires) and being loaded with no tire load. In the present specification, dimensions and the like of various parts of the tire are values measured in the standard state unless otherwise noted.

The term “standard rim” refers to a wheel rim specified for the concerned tire by a standard included in a standardization system on which the tire is based, for example, the “normal wheel rim” in JATMA, “Design Rim” in TRA, and “Measuring Rim” in ETRTO.

The term “standard inner pressure” refers to air pressure specified for the concerned tire by a standard included in a standardization system on which the tire is based, for example, the maximum air pressure in JATMA, maximum value listed in the “TIRE LOAD LIMITS AT VARIOUS COLD INFLATION PRESSURES” table in TRA, and “INFLATION PRESSURE” in ETRTO.

In the case of tires for which various standards have been established, the term “standard tire load” refers to a tire load specified for the concerned tire by a standard included in a standardization system on which the tire is based, for example, the “maximum load capacity” in JATMA, maximum value listed in “TIRE LOAD LIMITS AT VARIOUS COLD INFLATION PRESSURES” table in TRA, and “LOAD CAPACITY” in ETRTO. Further, in the case of tires for which various standards have not been established or non-pneumatic tires, the “standard tire load” refers to the maximum load that can be applied to the tire in accordance with the standards described above.

The circumferential grooves 3 include a first shoulder circumferential groove 5 and a second shoulder circumferential groove 6, and a first crown circumferential groove 7 and a second crown circumferential groove 8 provided between the first and second shoulder circumferential grooves. The first shoulder circumferential groove 5 is provided closest to the first tread edge T1 among the plurality of circumferential grooves 3. The second shoulder circumferential groove 6 is provided closest to the second tread edge T2 among the plurality of circumferential grooves 3. The first crown circumferential groove 7 is provided between the first shoulder circumferential groove 5 and the tire equator (C). The second crown circumferential groove 8 is provided between the second shoulder circumferential groove 6 and the tire equator (C).

It is preferred that a distance (L1) in the tire axial direction from the tire equator (C) to the groove center line of the first shoulder circumferential groove 5 or the second shoulder circumferential groove 6 is in the range from 20% to 35% of the tread width TW, for example. It is preferred that a distance (L2) in the tire axial direction from the tire equator (C) to the groove center line of the first crown circumferential groove 7 or the second crown circumferential groove 8 is in the range from 5% to 15% of the tread width TW, for example. It should be noted that the tread width TW is the distance in the tire axial direction from the first tread edge T1 to the second tread edge T2 in the standard state.

It should be noted that when numerical ranges of various parameters are described in the present specification, unless otherwise specified, the above-mentioned numerical ranges mean the numerical ranges of the average values of the parameters. In addition, the above-mentioned “average value” includes values obtained by, for example, dividing the measurement target of the parameter into multiple microregions of appropriate size, measuring the parameter for each microregion, and dividing the sum of the obtained parameters in each microregion by the number of divided microregions.

It is preferred that each of the circumferential grooves 3 has a groove width W1 of at least 3 mm or more. Further, it is preferred that the groove width W1 of each of the circumferential grooves 3 is in the range from 3.0% to 7.0% of the tread width TW, for example. Furthermore, each of the circumferential grooves 3 has a depth in the range from 5 to 10 mm, for example, in the case of a pneumatic tire for a passenger car.

The plurality of land regions 4 of the present embodiment include a crown land region 10, a first middle land region 11, a second middle land region 12, a first shoulder land region 13, and a second shoulder land region 14. The crown land region 10 of the present embodiment is demarcated between the first crown circumferential groove 7 and the second crown circumferential groove 8. Thereby, the crown land region 10 is provided on the tire equator (C). The first middle land region 11 is demarcated between the first shoulder circumferential groove 5 and the first crown circumferential groove 7. The second middle land region 12 is demarcated between the second shoulder circumferential groove 6 and the second crown circumferential groove 8. The first shoulder land region 13 is demarcated on the axially outer side of the first shoulder circumferential groove 5 and includes the first tread edge T1. The second shoulder land region 14 is demarcated on the axially outer side of the second shoulder circumferential groove 6 and includes the second tread edge T2.

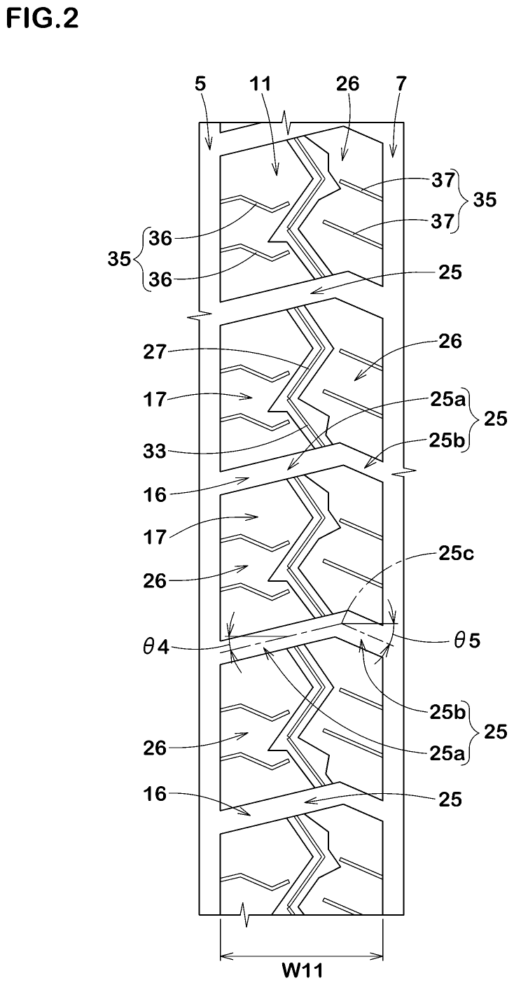

FIG. 2 shows an enlarged view of the first middle land region 11 of FIG. 1 as an example of the block row. As shown in FIG. 2, the first middle land region 11 is the block row including a plurality of first middle blocks 26 separated by a plurality of first middle axial grooves 25.

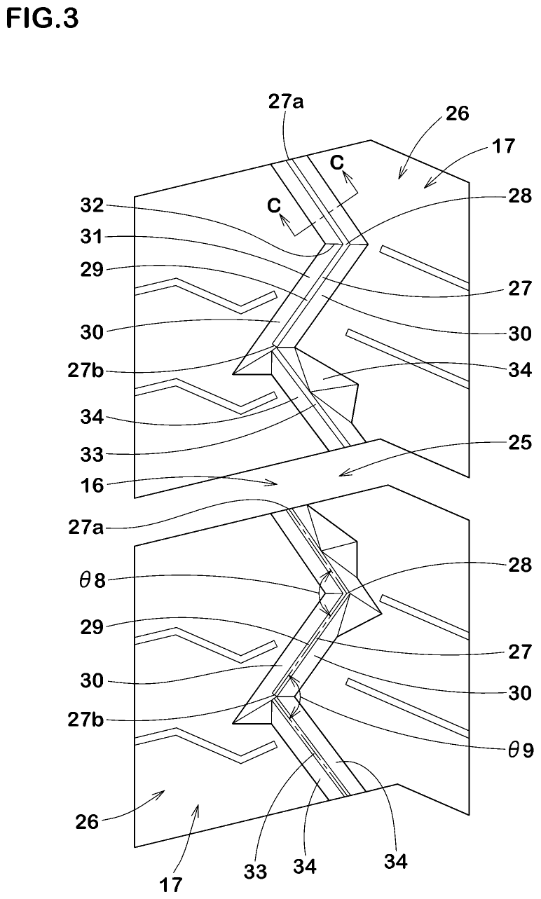

FIG. 3 is an enlarged view of two of the first middle blocks 26. In the present disclosure, each of the plurality of blocks 17 (first middle blocks 26 in the present embodiment) is provided with one circumferential sipe 27. This circumferential sipe 27 communicates with at least one axial groove 16 (the first middle axial groove 25 in the present embodiment) and extends in the tire circumferential direction. Further, the circumferential sipe 27 includes at least one bent portion 28 that is locally bent.

In the present specification, the term “sipe” refers to an incision having a small width, in which the width between two sipe walls is 1.5 mm or less in the sipe main body portion. Further, the sipe main body portion refers to a portion where the two sipe walls extend substantially parallel to each other in the tire radial direction. The expression “substantially parallel” means an aspect in which the angle between the two sipe walls is 10 degrees or less. As described later, the sipe may have a chamfered portion formed on an edge thereof. Further, the sipe may be provided with a so-called flask bottom in which the width is increased at the bottom portion.

With the above-described configuration, the two sipe walls in the sipe main body portion come into contact with each other when ground contact pressure is applied to the sipe, thereby, the rigidity of the portion where the sipe is arranged can be maintained. It should be noted that in the present specification, each of the grooves can maintain a substantial drainage path since two groove walls thereof do not come into contact even when ground contact pressure is applied. From this point of view, the groove width of each of the grooves is 2.0 mm or more, for example.

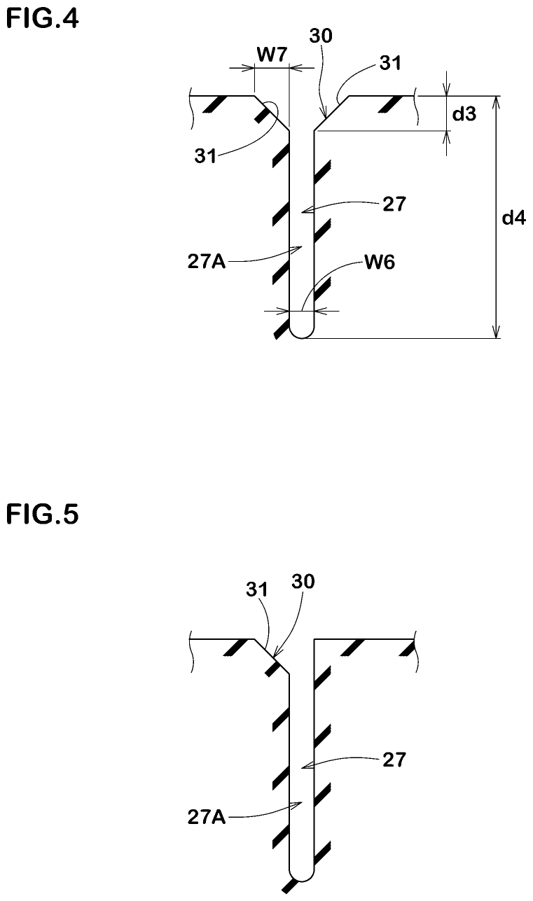

FIG. 4 shows a cross-sectional view taken along the C-C line in FIG. 3. As shown in FIG. 4, at least one of the edges of the circumferential sipe 27 in the present embodiment is provided with a chamfered portion 30. The chamfered portion 30 means a region where the edge angle formed by the ground contact surface of the block and one of the sipe walls of the sipe main body portion 27A is removed. Therefore, the chamfered portion 30 includes, in a cross section perpendicular to the longitudinal direction of the circumferential sipe 27, an inclined surface 31 extending from the ground contact surface of the block at an angle with respect to the normal line of the tire. It is preferred that a width W7 of the inclined surface 31 of the chamfered portion 30 is at least 50% or more of a width W6 of the sipe main body portion 27A.

By adopting the above configuration, the tire 1 of the present disclosure can improve the running performance on snowy road surfaces (hereinafter may be referred to as “on-snow performance”) while maintaining the steering stability on dry road surfaces (hereinafter may be simply referred to as “steering stability”). The mechanism is as follows.

As shown in FIG. 3, in the tire of the present disclosure, each of the blocks 17 is provided with the circumferential sipe 27 having the bent portion 28. The circumferential sipes 27 configured as such provide frictional force in the tire axial direction on snowy road surfaces, therefore, the running performance on snowy road surfaces is improved.

Further, in each of the circumferential sipe 27 including the bent portion 28, the two sipe walls facing each other engage with each other, thereby, a decrease in the rigidity of the blocks 17 can be suppressed. Furthermore, in the present disclosure, since the chamfered portion 30 is formed on at least one of the edges of each of the circumferential sipes 27, even when a large load is applied to the blocks, such as during cornering on a dry road surface, the ground contact pressure is not concentrated on the edges of the circumferential sipes, therefore, the ground contact pressure acting on the blocks 17 can be made uniform. Thereby, the steering stability on dry road surfaces can be maintained.

A more detailed configuration of the present embodiment will be explained below. Each of the configurations described below shows a specific form of the present embodiment. Therefore, it goes without saying that the present disclosure can exert the effects described above even if it does not have the configuration described below. Even if any one of the configurations described below is applied alone to the tire of the present disclosure, which has the features described above, the performance can be expected to improve according to each configuration. Further, when some of the configurations described below are applied in combination, a combined performance improvement can be expected depending on each configuration.

The chamfered portion 30 in the present embodiment is formed on each of the edges on both sides of each of the circumferential sipe 27. In another embodiment, the chamfered portion 30 may be formed on only one edge of each of the circumferential sipes 27, as shown in FIG. 5. Further, the inclined surface 31 of the present embodiment has a planar shape with a straight line in a cross section thereof. In yet another embodiment, the inclined surface 31 may be configured as a convex or concave surface so as to be curved in an arc shape in a cross section thereof, or may be bent in a cross section thereof.

As shown in FIG. 4, from the point of view of making the ground contact pressure more uniform, the width W7 of the inclined surface 31 (the width of the inclined surface in a plan view of the ground contact surface) is preferably 0.5 mm or more, more preferably 1.0 mm or more, and preferably 2.0 mm or less, more preferably 1.5 mm or less. Similarly, the chamfered portion 30 has a chamfer depth (d3) in the range from 0.5 to 2.0 mm.

The circumferential sipe 27 has the maximum depth (d4) in the range from 50% to 100% of the maximum height (not shown) of the block (first middle block 26) in which the circumferential sipe 27 is provided. Therefore, it is possible that the on-snow performance is reliably maintained.

As shown in FIG. 3, it is preferred that the chamfered portion 30 is formed over the entire length of each of the circumferential sipes 27. Thereby, this can be expected to suppress uneven wear in addition to improving the steering stability. It should be noted that ridge lines 32 formed by the inclined surfaces 31 of the chamfered portions 30 are shown as thin lines in FIG. 3 (these ridge lines 32 are omitted in FIG. 1 and FIG. 2).

It is preferred that each of the circumferential sipes 27 has a bending angle θ8 in the range from 90 to 135 degrees at the bent portion 28 thereof. Therefore, the steering stability and the on-snow performance are improved in a well-balanced manner. It should be noted that the bending angle θ8 is an angle measured at the center line of each of the circumferential sipe 27.

Each of the circumferential sipes 27 has a first end (27a) communicating with one of the first middle axial grooves 25 (shown in FIG. 2) immediately adjacent thereto and a second end (27b) terminating within the block to have a closed terminating end. Further, each of the first middle blocks 26 is provided with a sub-circumferential sipe 33. In each of the blocks 17 (the first middle blocks 26 in the present embodiment), the sub-circumferential sipe 33 communicates with other first middle axial groove 25 located on the opposite side of the first middle axial groove 25 with which the circumferential sipe 27 communicates, and extends in the tire circumferential direction. The sub-circumferential sipe 33 terminates within the first middle block 26 to have a closed terminating end. Furthermore, the shortest distance between the terminating end of the sub-circumferential sipe 33 and the terminating end of the circumferential sipe 27 is 2.0 mm or less. As a result, the rigidity of the first middle blocks 26 can be maintained, therefore, the steering stability can be improved, compared to the case where each of the first middle blocks 26 is provided with the circumferential sipe 27 that completely crosses the first middle block 26 in the tire circumferential direction.

Each of the sub-circumferential sipes 33 is provided with a chamfered portion 34. It is preferred that the chamfered portion 34 of the sub-circumferential sipe 33 is connected with the chamfered portion 30 of the circumferential sipe 27 in each of the blocks 17 (first middle blocks 26 in the present embodiment). Thereby, the steering stability and uneven wear resistance performance are improved.

The circumferential sipe 27 includes a portion 29 extending from the terminating end of the circumferential sipe 27 at an angle (i.e., obliquely) to a first side with respect to the tire circumferential direction. The sub-circumferential sipe 33 is inclined to a second side opposite to the first side with respect to the tire circumferential direction. This results in an abrupt change in the orientation of the sipes between the above-described portion 29 of the circumferential sipe 27 and the sub circumferential sipe 33. Further, an angle θ9 between them is in the range from 90 to 135 degrees, similar to the angle θ8 of the bent portion 28 of each of the circumferential sipes 27. The circumferential sipes 27 and the sub-circumferential sipes 33 configured as such can provide frictional force in multiple directions and thus improve the cornering performance on snow.

In another embodiment, for example, the circumferential sipe 27 and the sub-circumferential sipe 33 of the present embodiment may be connected (communicated) with each other to form a single circumferential sipe 27 completely crossing the block in the tire circumferential direction. Such embodiment can further improve the on-snow performance.

As shown in FIG. 2, the first middle axial grooves 25 extend in the tire axial direction from the first shoulder circumferential groove 5 to the first crown circumferential groove 7. Each of the first middle axial grooves 25 in the present embodiment includes (consists of in the present embodiment) a first groove portion (25a) and a second groove portion (25b), for example. The first groove portion (25a) and the second groove portion (25b) each extend linearly. The first groove portion (25a) communicates with the first shoulder circumferential groove 5 and extends obliquely with respect to the tire axial direction. The first groove portion (25a) has an angle θ4 (the angle of the groove center line, the same applies hereinafter) in the range from 10 to 20 degrees, for example, with respect to the tire axial direction. The second groove portion (25b) communicates with the first crown circumferential groove 7 and is inclined to a side opposite to the first groove portion (25a) with respect to the tire axial direction. The second groove portion (25b) has an angle θ5 from 15 to 25 degrees with respect to the tire axial direction, for example. The first middle axial grooves 25 each including the first groove portion (25a) and the second groove portion (25b) configured as such can provide snow shearing force in the tire axial direction during running on snow.

It is preferred that an intersection point (25c) of the groove center lines of the first groove portion (25a) and the second groove portion (25b) is located closer to the tire equator (C) (shown in FIG. 1) than the center position in the tire axial direction of the first middle land region 11. Thereby, a large ground contact pressure acts near the intersection point (25c), and a harder snow block is formed within each of the first middle axial grooves 25.

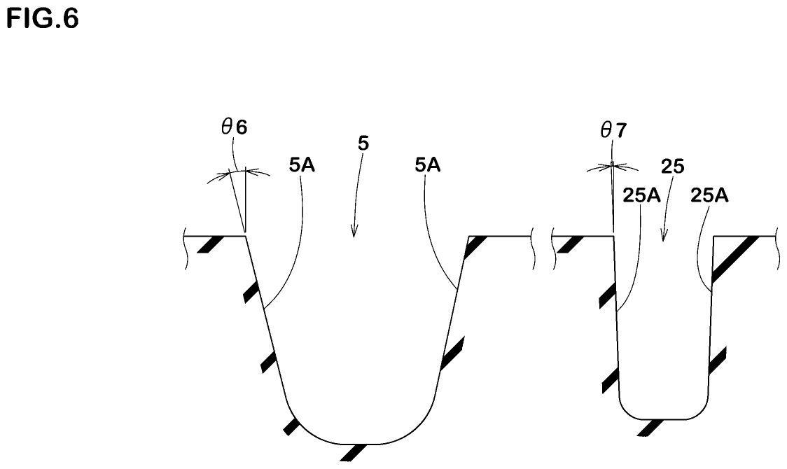

FIG. 6 shows a reference diagram in which an enlarged cross-sectional view of the first shoulder circumferential groove 5 and an enlarged cross-sectional view of one of the first middle axial grooves 25 are arranged side by side. As shown in FIG. 6, it is preferred that the first shoulder circumferential groove 5 has groove walls 5A each having an angle θ6 with respect to the tire normal line larger than an angle θ7 with respect to the tire normal line of each of groove walls 25A of each of the first middle axial grooves 25. Specifically, the angle θ6 is in the range from 10 to 15 degrees. The angle θ7 is in the range from 1 to 4 degrees. Therefore, the first middle land region 11 (shown in FIG. 2) has relatively high rigidity in the tire axial direction, thereby, the steering stability on a dry road surface can be improved.

As shown in FIG. 2, each of the first middle blocks 26 is provided with a plurality of first middle axial sipes 35 extending in the tire axial direction from the first shoulder circumferential groove 5 or from the first crown circumferential groove 7. It is preferred that each of the first middle axial sipes 35 terminates without communicating with the circumferential sipe 27 in each of the first middle blocks 26. The first middle axial sipes 35 configured as such can improve the steering stability and the on-snow performance in a good balance.

The first middle axial sipes 35 include (consist of in the present embodiment) outer first middle axial sipes 36 and inner first middle axial sipes 37. The outer first middle axial sipes 36 communicate with the first shoulder circumferential groove 5 and each extend in a zigzag shape. The inner first middle axial sipes 37 communicate with the first crown circumferential groove 7 and each extend in the tire axial direction linearly and obliquely with respect to the tire axial direction. As a result, the rigidity of the region on the first shoulder circumferential groove 5 side from the circumferential sipe 27 is relatively greater in each of the first middle blocks 26, therefore, the steering stability can be improved while maintaining the on-snow performance.

From the point of view of improving the steering stability and the on-snow performance in a good balance, the ground contact surface of the first middle land region 11 has a width W11 in the tire axial direction in the range from 14.1% to 15.3% and preferably from 14.8% to 15.3% of the tread width TW (shown in FIG. 1 and the same applies hereinafter), for example.

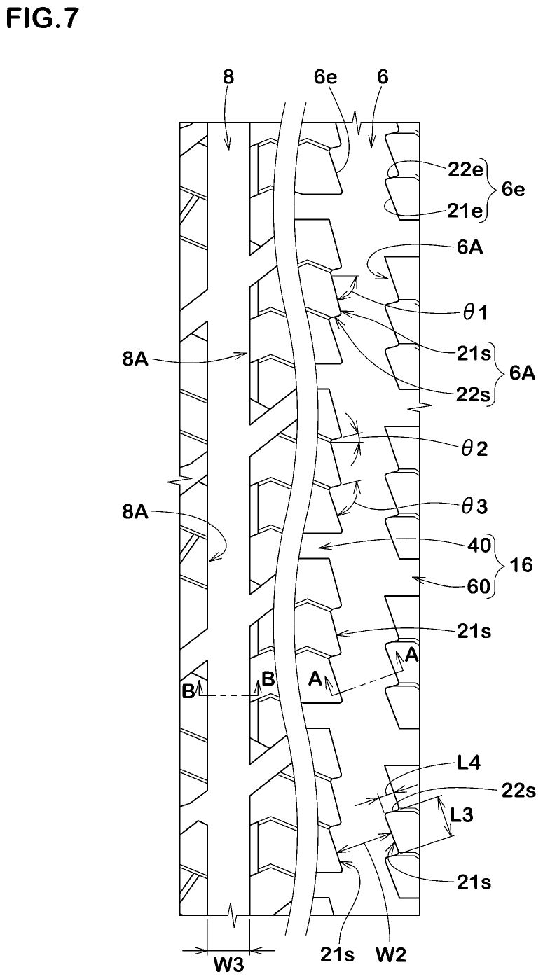

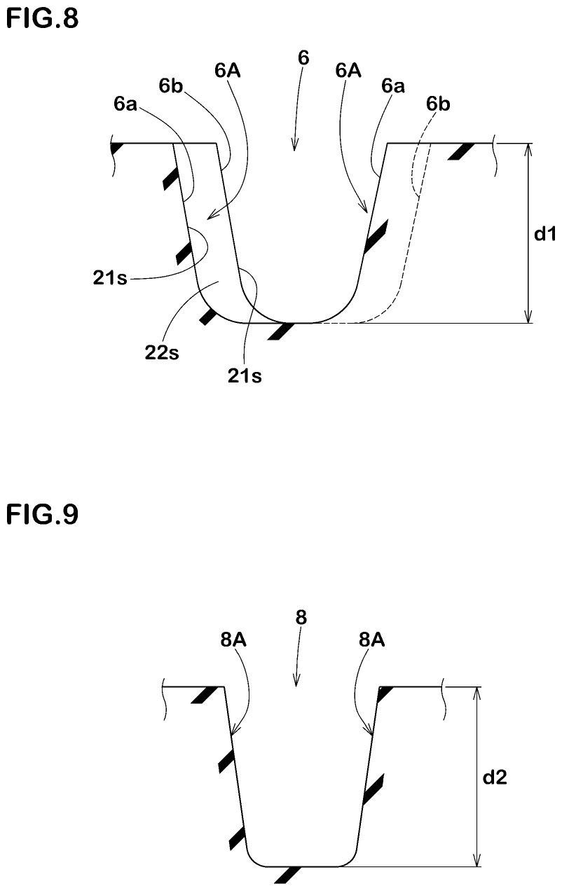

FIG. 7 shows an enlarged view of the second shoulder circumferential groove 6 and the second crown circumferential groove 8. It should be noted that the second middle land region 12 between these circumferential grooves is omitted in FIG. 7. FIG. 8 shows a cross-sectional view taken along A-A line in FIG. 7 as a diagram showing a lateral cross section of the second shoulder circumferential groove 6. FIG. 9 shows a cross-sectional view taken along B-B line in FIG. 7 as a diagram showing a lateral cross section of the second crown circumferential groove 8. As shown in FIG. 7 and FIG. 8, groove walls 6A on both sides of the second shoulder circumferential groove 6 are zigzag surfaces each having repeated displacements in the tire axial direction in the lateral cross section of the second shoulder circumferential groove 6. It should be noted that, in order to make this feature easier to understand, the outline of groove walls (6a) cut along the A-A line is shown as a solid line, and the outline of groove walls (6b) that deviate from the groove walls (6a) in the tire axial direction are shown as solid or dashed lines in FIG. 8.

On the other hand, as shown in FIG. 7 and FIG. 9, groove walls 8A on both sides of the second crown circumferential groove 8 are each flat surfaces extending parallel to the tire circumferential direction without displacement in the tire axial direction of the cross section of the second crown circumferential groove 8. In other words, for the second crown circumferential groove 8, the contour of the groove walls 8A shown in FIG. 9 does not move in the tire axial direction even when the cut plane shown by the B-B line in FIG. 7 is moved in the tire circumferential direction. As a result, while the second shoulder circumferential groove 6 forms a hard snow block, the second crown circumferential groove 8 can maintain the rigidity of the land regions on both sides thereof. Therefore, the steering stability and the on-snow performance are improved in a good balance.

As shown in FIG. 7, the second shoulder circumferential groove 6 has groove edges (6e) each extending in a zigzag shape. More specifically, each of the groove edges (6e) of the second shoulder circumferential groove 6 includes (consists of in the present embodiment) first edge portions (21e) extending at an angle close to the tire circumferential direction and second edge portions (22e) extending at an angle close to the tire axial direction. The second edge portions (22e) are each configured to have a length smaller than a length of each of the first edge portions (21e). The first edge portions (21e) and the second edge portions (22e) each extend linearly in the present embodiment.

The groove walls 6A on both sides of the second shoulder circumferential groove 6 each include first surfaces (21s) and second surfaces (22s) arranged alternately one by one in the tire circumferential direction. The first surfaces (21s) are flat surfaces each extending in the tire radial direction from a respective one of the first edge portions (21e). The second surfaces (22s) extend in a direction different from the first surfaces (21s), and specifically, are flat surfaces each extending in the tire radial direction from a respective one of the second edge portions (22e). It should be noted that, as shown in FIG. 8, the first surfaces (21s) and the second surfaces (22s) are inclined with respect to the tire radial direction, depending on the draft angles that the groove walls 6A of the second shoulder circumferential groove 6 normally have. As shown in FIG. 7, the groove walls 6A of the second shoulder circumferential groove 6 in the present embodiment have the above-mentioned zigzag surfaces by including the first surfaces (21s) and the second surfaces (22s) arranged alternately one by one in the tire circumferential direction.

An angle θ1 of each of the first surfaces (21s) is preferably 60 degrees or more, more preferably 65 degrees or more, and preferably 80 degrees or less, and even more preferably 75 degrees or less with respect to the tire axial direction. Further, an angle θ2 of each of the second surfaces (22s) with respect to the tire axial direction is preferably 10 degrees or more, more preferably 15 degrees or more, and preferably 30 degrees or less, and more preferably 25 degrees or less. Therefore, in each pair of one of the first surfaces (21s) and one of the second surfaces (22s) immediately adjacent to each other in the tire circumferential direction, an angle θ3 between the first surface (21s) and the second surface (22s) is set in the range from 80 to 110 degrees. The groove walls 6A including the first surfaces (21s) and the second surfaces (22s) configured as such help to form solid snow blocks during running on snow. It should be noted that that the angles θ1, θ2, and θ3 described above are measured at the groove edges, for example.

From the point of view of forming solid snow blocks within the second shoulder circumferential groove 6, it is preferred that each of the first surfaces (21s) has a length L3 in the direction along the second shoulder circumferential groove 6 smaller than a groove width W2 of the second shoulder circumferential groove 6. Specifically, the length L3 of each of the first surfaces (21s) is from 60% to 90%, preferably from 70% to 80% of the groove width W2 of the second shoulder circumferential groove 6. As a result, the on-snow performance is improved while uneven wear on the groove edges of the second shoulder circumferential groove 6 is suppressed. It should be noted that the groove width W2 is the width in the direction perpendicular to the groove center line of the second shoulder circumferential groove 6, and in the present embodiment, the groove width W2 is the width from the groove edge of the first surface (21s) on the second tread edge T2 (shown in FIG. 1) side to the groove edge of the first surface (21s) on the tire equator (C) (shown in FIG. 1) side in the direction perpendicular to the groove center line.

A length L4 (so-called periphery length) of each of the second surfaces (22s) is 50% or less and preferably from 20% to 40% of the length L3 of each of the first surfaces (21s), for example. Therefore, traction performance on snow is improved while the uneven wear of the groove edges (6e) of the second shoulder circumferential groove 6 is suppressed.

The groove walls 6A on both sides of the second shoulder circumferential groove 6 in the present embodiment are each divided or demarcated in the tire circumferential direction by the axial grooves 16 (second middle axial grooves 40 and second shoulder axial grooves 60, which will be described later) that communicate with the second shoulder circumferential groove 6. The groove walls of the second shoulder circumferential groove 6 on both sides thereof each have two to four first surfaces (21s) between two axial grooves 16 adjacent to each other in the tire circumferential direction. Thereby, the on-snow performance and the steering stability on dry road surfaces are improved in a good balance.

From the point of view of reliably improving the on-snow performance, it is preferred that the groove width W2 of the second shoulder circumferential groove 6 is larger than a groove width W3 of the second crown circumferential groove 8. Specifically, the groove width (W2) of the second shoulder circumferential groove 6 is in the range from 105% to 110% of the groove width W3 of the second crown circumferential groove 8. Therefore, the steering stability is improved while the on-snow performance is maintained.

As shown in FIG. 8 and FIG. 9, the second crown circumferential groove 8 has a depth (d1) in the range from 100% to 105% of a depth (d2) of the second shoulder circumferential groove 6. Thereby, the steering stability on dry road surfaces can be improved.

As shown in FIG. 1, the first shoulder circumferential groove 5 and the first crown circumferential groove 7 in the present embodiment have groove walls similar to those of the second crown circumferential groove 8. That is, the groove walls of the first shoulder circumferential groove 5 and the first crown circumferential groove 7 on both sides thereof are flat surfaces extending parallel to the tire circumferential direction so that the lateral cross sections thereof are not displaced in the tire axial direction (not shown). Therefore, the steering stability on dry road surfaces are further improved.

It is preferred that the first crown circumferential groove 7 has a groove width W4 smaller than the groove width W2 (shown in FIG. 7) of the second shoulder circumferential groove 6 and smaller than the groove width W3 (shown in FIG. 7) of the second crown circumferential groove 8. Further, it is preferred that the first shoulder circumferential groove 5 has a groove width W5 larger than the groove width W4 of the first crown circumferential groove 7 and larger than the groove width W3 of the second crown circumferential groove 8. Thereby, the steering stability on dry road surfaces and the on-snow performance are improved in a good balance.

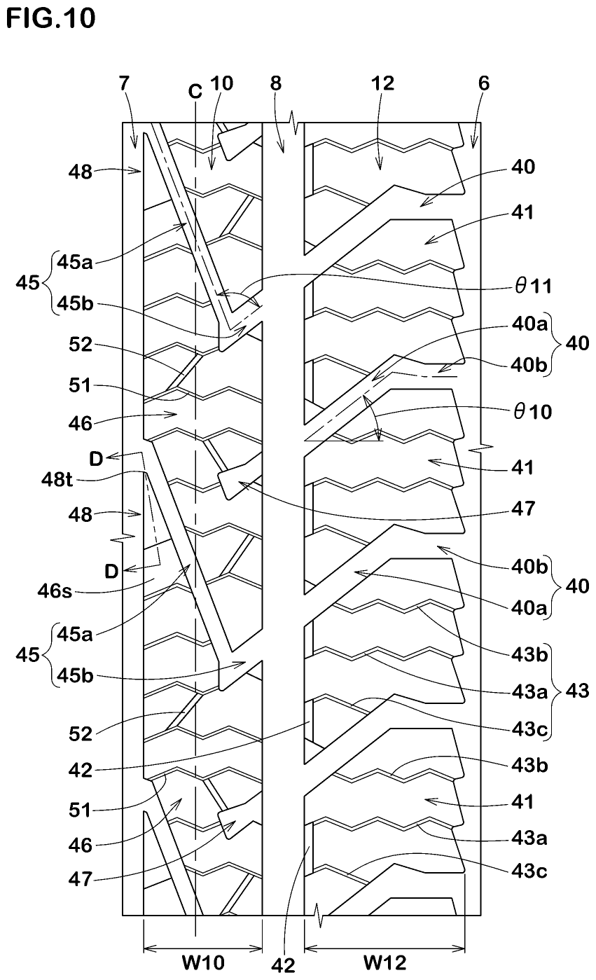

FIG. 10 shows an enlarged view of the second middle land region 12 and the crown land region 10 of FIG. 1. As shown in FIG. 10, the second middle land region 12 is a block row including a plurality of second middle blocks 41 separated by a plurality of the second middle axial grooves 40.

From the point of view of improving the steering stability and the on-snow performance in a good balance, a width W12 in the tire axial direction of the ground contact surface of the second middle land region 12 is from 14.1% to 15.3%, and preferably from 14.8% to 15.3% of the tread width TW (shown in FIG. 1), for example.

The second middle axial grooves 40 extend in the tire axial direction from the second shoulder circumferential groove 6 to the second crown circumferential groove 8. Each of the second middle axial grooves 40 in the present embodiment includes (consists of in the present embodiment) a first groove portion (40a) and a second groove portion (40b), for example. Each of the first groove portion (40a) and the second groove portion (40b) extends linearly. The first groove portion (40a) communicates with the second crown circumferential groove 8 and extends obliquely with respect to the tire axial direction. The first groove portion (40a) has an angle θ10 in the range from 30 to 50 degrees with respect to the tire axial direction, for example. The second groove portion (40b) communicates with the second shoulder circumferential groove 6 and extends at an angle smaller than the first groove portion (40a) with respect to the tire axial direction. The angle of the second groove portion (40b) is 10 degrees or less with respect to the tire axial direction. The first middle axial grooves 25 including the first groove portions (40a) and the second groove portions (40b) configured as such, together with the second shoulder circumferential groove 6 described above, can improve the steering stability and the on-snow performance in a good balance.

The second middle blocks 41 in the present embodiment are provided with partially chamfered portions 42 in which the edge angles between the ground contact surfaces of the second middle blocks 41 and the axially outer groove wall of the second crown circumferential groove 8 are cut out, for example. As a result, the uneven wear of the second middle blocks 41 is suppressed.

Each of the second middle blocks 41 is provided with a plurality of second middle sipes 43 extending in the tire axial direction. Each of the second middle sipes 43 extends in a zigzag shape. The second middle sipes 43 configured as such can improve the on-snow performance while maintaining the rigidity of the second middle blocks 41.

The second middle sipes 43 include large second middle sipes (43a), medium second middle sipes (43b), and small second middle sipes (43c). Each of the large second middle sipes (43a) extends from the second shoulder circumferential groove 6 to the second crown circumferential groove 8. Each of the medium second middle sipes (43b) extends from the second shoulder circumferential groove 6 to the first groove portion (40a) of one of the second middle axial grooves 40 adjacent thereto. Each of the small second middle sipes (43c) extends from the first groove portion (40a) of one of the second middle axial grooves 40 adjacent thereto to the second crown circumferential groove 8. Each of the second middle blocks 41 in the present embodiment is provided with one large second middle sipe (43a), one medium second middle sipe (43b), and one small second middle sipe (43c). Therefore, the steering stability on dry road surfaces and the on-snow performance are improved in a good balance.

The crown land region 10 is a block row including a plurality of crown blocks 46 separated by a plurality of crown axial grooves 45.

The crown land region 10 has a width W10 in the tire axial direction of 13% or less, and preferably from 10.8% to 11.5%, of the tread width TW (shown in FIG. 1), for example.

Each of the crown axial grooves 45 extends from the first crown circumferential groove 7 to the second crown circumferential groove 8. Each of the crown axial grooves 45 in the present embodiment includes (consists of in the present embodiment) a first groove portion (45a) inclined in a first direction with respect to the tire axial direction, and a second groove portion (45b) inclined in a direction opposite to the first groove portion (45a) with respect to the tire axial direction. The first groove portion (45a) and the second groove portion (45b) each extend linearly and are inclined at an angle from 40 to 70 degrees with respect to the tire axial direction. Accordingly, an angle θ11 between the first groove portion (45a) and the second groove portion (45b) is from 70 to 90 degrees in each of the crown axial grooves 45. The crown axial grooves 45 having the first groove portions (45a) and the second groove portions (45b) configured as such can form hard snow blocks inside, and therefore, the on-snow performance can be further improved.

Each of the first groove portions (45a) preferably crosses the center position in the tire axial direction of the crown land region 10, and more preferably crosses the tire equator (C), for example. Thereby, hard snow blocks are formed in the first groove portions (45a), therefore, the cornering performance on snow is improved.

It is preferred that, in each pair of one of the crown axial grooves 45 and one of the second middle axial grooves 40 adjacent to each other, the second groove portions (45b) of the crown axial groove 45 overlaps with a virtual region obtained by extending the first groove portion (40a), in the length direction thereof, of the second middle axial groove 40, for example. As a result, during running on snow, the crown axial grooves 45 and the second middle axial grooves 40 can cooperate to form long snow blocks in the tire axial direction, therefore, the traction performance on snow is improved.

Each of the crown blocks 46 is provided with a single crown short groove 47. The crown short groove 47 extends from the second crown circumferential groove 8 to terminate within the crown block 46, for example. The crown short groove 47 is inclined to the same side as the second groove portions (45b) of the crown axial grooves 45 with respect to the tire axial direction, and in a preferred embodiment, the angular difference between these is 10 degrees or less. Further, in each pair of one of the crown short grooves 47 and one of the second middle axial grooves 40 adjacent to each other, it is preferred that the crown short groove 47 overlaps with a virtual region obtained by extending the first groove portion (40a), in the length direction thereof, of the second middle axial groove 40. The crown short grooves 47 configured as such can improve the on-snow performance while maintaining the rigidity of the crown blocks 46.

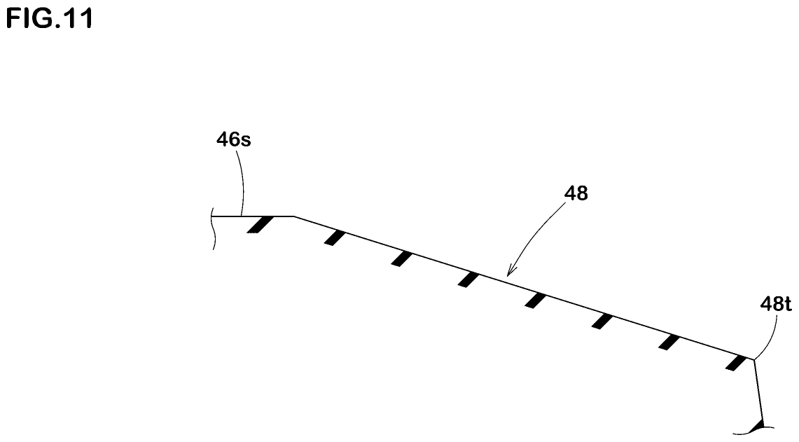

Each of the crown blocks 46 is provided with a tapered portion 48 between the first crown circumferential groove 7 and the first groove portion (45a) of one of the crown axial grooves 45, in the present embodiment, the first groove portion (45a) farther away from the crown short groove 47, for example. The tapered portion 48 has a width decreasing toward the end in the tire circumferential direction of the crown block 46. In other words, the tapered portion 48 in the present embodiment has the width decreasing toward the connection of the farther away first groove portion (45a) with the first crown circumferential groove 7. FIG. 11 shows a cross-sectional view taken along D-D line in FIG. 10. As shown in FIG. 11, the tapered portion 48 is provided with a planar chamfer. The tapered portions 48 configured as such cooperate with the crown axial grooves 45 and the first crown circumferential groove 7 (shown in FIG. 10) to compact the snow and improve the traction performance on snow.

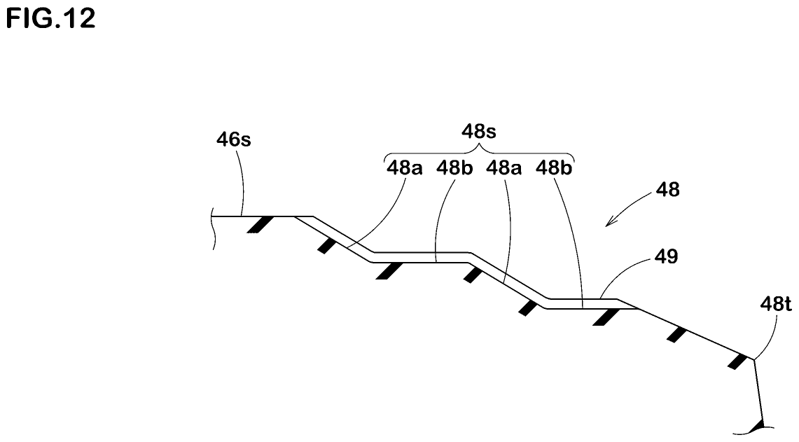

FIG. 12 shows an enlarged cross-sectional view of the tapered portion 48 of each of the crown blocks 46 in another embodiment of the present disclosure. The tapered portion 48 of this embodiment has a stepped outer surface (48s) in which first surfaces (48a) and second surfaces (48b) are arranged alternately one by one. The first surfaces (48a) are inclined with respect to a ground contact surface (46s) of the crown block 46. The second surfaces (48b) extend along the ground contact surface (46s). This outer surface (48s) is provided with a plurality of protruding ribs 49 locally protruding and extending toward a tip (48t) of the tapered portion 48. The tapered portions 48 configured as such can prevent snow from clogging the first crown circumferential groove 7 and the crown axial grooves 45 (shown in FIG. 10) while preventing the crown blocks 46 from chipping.

As shown in FIG. 10, each of the crown blocks 46 is provided with a plurality of first crown sipes 51 each extending in the tire axial direction in a zigzag manner and a plurality of second crown sipes 52 each having at least one end communicating with one of the first crown sipes 51. Each of the first crown sipes 51 extends in a zigzag shape from the first crown circumferential groove 7 to the second crown circumferential groove 8 or from the first crown circumferential groove 7 to one of the crown axial grooves 45. Each of the second crown sipes 52 extends linearly and either communicates with two of the first crown sipes 51 adjacent to each other in the tire circumferential direction or extends from one of the crown short grooves 47 to one of the first crown sipes 51 adjacent thereto. The first crown sipes 51 and the second crown sipes 52 configured as such can provide frictional force in multiple directions by edges thereof.

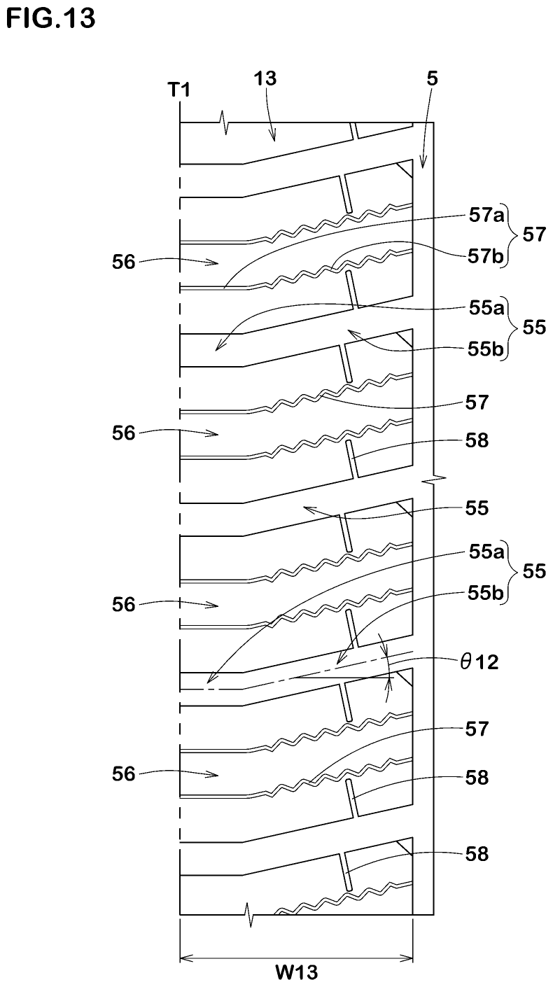

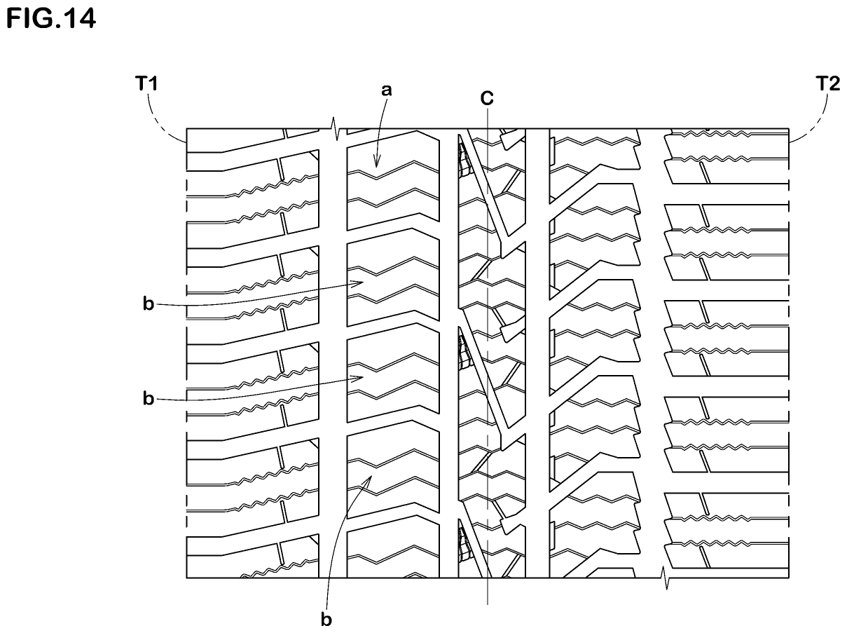

FIG. 13 shows an enlarged view of the first shoulder land region 13 of FIG. 1. As shown in FIG. 13, the first shoulder land region 13 is a block row including a plurality of first shoulder blocks 56 separated by a plurality of first shoulder axial grooves 55.

The ground contact surface of the first shoulder land region 13 has a width W13 in the tire axial direction of 15.4% or more of the tread width TW, and specifically and preferably in the range from 15.4% to 15.7% of the tread width TW, for example. Therefore, the steering stability and the on-snow performance are improved in a good balance.

Each of the first shoulder axial grooves 55 includes (consists of in the present embodiment) a first groove portion (55a) and a second groove portion (55b) located on the axially inner side of the first groove portion, for example. The second groove portion (55b) extends from the first shoulder circumferential groove 5 to the first groove portion (55a), for example. The first groove portion (55a) extends axially outward from the second groove portion (55b) so as to cross the first tread edge T1, for example. The first groove portion (55a) has an angle of 10 degrees or less with respect to the tire axial direction. The second groove portion (55b) is inclined at an angle larger than the first groove portion (55a) with respect to the tire axial direction. The second groove portion (55b) has an angle θ12 in the range from 10 to 20 degrees with respect to the tire axial direction, for example.

Each of the first shoulder blocks 56 is provided with a plurality of shoulder axial sipes 57 and a plurality of shoulder circumferential sipes 58. Each of the shoulder axial sipes 57 extends from the first shoulder circumferential groove 5 to the first tread edge T1. Each of the shoulder axial sipes 57 includes (consists of in the present embodiment) a first sipe portion (57a) and a second sipe portion (57b). The first sipe portion (57a) extends linearly in parallel with the first groove portions (55a) of the first shoulder axial grooves 55. The second sipe portion (57b) extends in a zigzag shape and is inclined to the same side as the second groove portions (55b) of the first shoulder axial grooves 55. In a preferred embodiment, the second sipe portion (57b) is configured as a so-called 3D sipe extending in a zigzag shape also in the tire radial direction in a cross section thereof. The shoulder axial sipes 57 configured as such can improve the on-snow performance while maintaining the rigidity of the first shoulder blocks 56.

Each of the shoulder circumferential sipes 58 extends from a respective one of the first shoulder axial grooves 55 and terminates within a respective one of the first shoulder blocks 56, for example. It is preferred that the shoulder circumferential sipes 58 terminate without communicating with any of the shoulder axial sipes 57. The shoulder circumferential sipes 58 configured as such help to improve the steering stability and the on-snow performance in a good balance.

As shown in FIG. 1, the second shoulder land region 14 is a block row including a plurality of second shoulder blocks 61 separated by a plurality of the second shoulder axial grooves 60. The ground contact surface of the second shoulder land region 14 has a width W14 in the tire axial direction of 15.4% or more of the tread width TW, for example, and specifically in the range from 15.4% to 15.7%.

Each of the second shoulder blocks 61 is provided with the shoulder axial sipes 57 and the shoulder circumferential sipes 58 similar to those of the first shoulder blocks 56. The above configuration can be applied to these.

It is preferred that a value of edge component amount of the axial grooves per unit area Evt/St (mm/mm²) is in the range from 0.09 to 0.12 (mm/mm²), wherein Evt (mm) is the total sum of the edge components of the axial grooves 16 on the ground contact surface of the tread portion 2, and St is an area (mm²) of the virtual tread surface obtained by filling all the circumferential grooves 3, the axial grooves 16, and the sipes provided in the tread portion 2. Thereby, the on-snow performance can be improved while the steering stability on dry road surfaces is maintained.

While detailed description has been made of the tire according to an embodiment of the present disclosure, the present disclosure can be embodied in various forms without being limited to the illustrated embodiment.

### EXAMPLES

As tires in Examples, pneumatic tires of size 215/55R17 having the basic pattern shown in FIG. 1 were made by way of test. As tires in Reference, pneumatic tires having the tread portion shown in FIG. 14 were made by way of test. In the tires in the Reference, first middle blocks (b) of a first middle land region (a) are not provided with circumferential sipes and chamfered portions. The tires in the Reference had substantially the same configuration as the tires in the Examples except for the above-mentioned matters.

The tires in the Reference and the Examples were tested for the steering stability on dry road surfaces and the running performance on snowy road surfaces. The common specification of the test tires and the test methods were as follows.
tire rim: 17×7.5 J
Tire inner pressure: 240 kPa on all wheels
Test vehicle: front wheel drive car with displacement of 2500 cc
Tire mounting position: all wheels

### Steering Stability on Dry Road Surface

While a test driver drove the above test vehicle on a dry road surface, the steering stability was evaluated based on the driver's sensory perception. The results are indicated by an evaluation point based on the steering stability of the Reference being 100, wherein the larger the numerical value, the better the steering stability is. It should be noted that if the steering stability is 90 points or higher, the steering stability is certified as being maintained in this test.

### Running Performance on Snowy Road Surface

While the test driver drove the above test vehicle on a snowy road surface, the running performance was evaluated based on the driver's sensory perception. The results are indicated by an evaluation point based on the running performance of the Reference being 100, wherein the larger the numerical value, the better the running performance is.

The test results are shown in Table 1.

TABLE 1
(1/2)

| | | | Ex. 2 |
|---|---|---|---|
| Figure showing Tread portion | Ref. FIG. 14 | Ex. 1 FIG. 1 | FIG. 1 |
| Depth (d4) of Circumferential sipe/ Height of block [%] | — | 70 | 20 |
| Bending angle θ8 of Bent portion of Circumferential sipe | — | 110 | 110 |
| [degree] | | | |
| Width W7 of Inclined surface of Chamfered portion | — | 1.5 | 1.5 |
| [mm] | | | |
| Chamfer depth (d3) of Chamfered portion [mm] | — | 1.5 | 1.5 |
| Steering stability on dry road surfaces [evaluation point] | 100 | 98 | 100 |
| Running performance on snowy road surfaces [evaluation | 100 | 110 | 105 |
| point] | | | |

(2/2)

| | Ex. 3 | Ex. 4 | Ex. 5 |
|---|---|---|---|
| Figure showing Tread portion | FIG. 1 | FIG. 1 | FIG. 1 |
| Depth (d4) of Circumferential sipe/ Height of block [%] | 70 | 70 | 70 |
| Bending angle θ8 of Bent portion of Circumferential sipe | 70 | 160 | 110 |
| [degree] | | | |
| Width W7 of Inclined surface of Chamfered portion | 1.5 | 1.5 | 2.5 |
| [mm] | | | |
| Chamfer depth (d3) of Chamfered portion [mm] | 1.5 | 1.5 | 2.5 |
| Steering stability on dry road surfaces [evaluation point] | 93 | 93 | 93 |
| Running performance on snowy road surfaces [evaluation | 107 | 107 | 107 |
| point] | | | |

From the test results, it was confirmed that the tires in the Examples improved the running performance on snowy road surfaces while maintaining the steering stability on dry road surfaces.

### Statement of Disclosure

The present disclosure includes the following aspects.

### Present Disclosure 1

A tire having a tread portion including:
a plurality of axial grooves;
a plurality of blocks separated by the plurality of axial grooves; and
a block row including the plurality of blocks,
wherein each of the blocks is provided with one circumferential sipe,
the circumferential sipe extends in the tire circumferential direction so as to communicate with at least one of the axial grooves and has one or more bent portions bent locally, and
at least one of edges of the circumferential sipe is provided with a chamfered portion.

### Present Disclosure 2

The tire according to Present Disclosure 1, wherein the chamfered portion is formed over the entire length of the circumferential sipe.

### Present Disclosure 3

The tire according to Present Disclosure 1, wherein each of the edges of the circumferential sipe on both sides thereof is provided with the chamfered portion.

### Present Disclosure 4

The tire according to Present Disclosure 1, wherein the circumferential sipe completely crosses the each of the blocks in the tire circumferential direction.

### Present Disclosure 5

The tire according to any one of Present Disclosures 1 to 3, wherein
the circumferential sipe has a first end communicating with one of the axial grooves and a second end terminating within the each of the blocks to have a terminating end,
each of the blocks is provided with a sub-circumferential sipe,
the sub-circumferential sipe communicates with another one of the axial grooves located on a side opposite to the axial groove communicating with the first end of the circumferential sipe, and extends therefrom in the tire circumferential direction to terminate within the each of the blocks to have a terminating end, and
the shortest distance between the terminating end of the circumferential sipe and the terminating end of the sub-circumferential sipe is 2.0 mm or less.

### Present Disclosure 6

The tire according to Present Disclosure 5, wherein
the sub-circumferential sipe is provided with a chamfered portion, and
the chamfered portion of the sub-circumferential sipe is connected with the chamfered portion of the circumferential sipe.

### Present Disclosure 7

The tire according to Present Disclosure 5 or 6, wherein
the circumferential sipe includes a portion extending obliquely from the terminating end thereof to a first side with respect to the tire circumferential direction, and
the sub-circumferential sipe is inclined to a second side opposite to the first side with respect to the tire circumferential direction.

### Present Disclosure 8

The tire according to Present Disclosure 1, wherein the circumferential sipe has the maximum depth in the range from 50% to 100% of the maximum height of the each of the blocks.

### Present Disclosure 9

The tire according to any one of Present Disclosures 1 to 8, wherein the circumferential sipe has a bending angle in the range from 90 to 135 degrees at the or each bent portion thereof.

### Present Disclosure 10

The tire according to any one of Present Disclosures 1 to 9, wherein
in a cross section perpendicular to the longitudinal direction of the circumferential sipe, the chamfered portion includes an inclined surface extending obliquely with respect to a normal line of the tire from a ground contact surface of the each of the blocks, and
the inclined surface has a width in the range from 0.5 to 2.0 mm in a plan view of the ground contact surface.

### Present Disclosure 11

The tire according to any one of Present Disclosures 1 to 10, wherein the chamfered portion has a chamfer depth in the range from 0.5 to 2.0 mm.

### Present Disclosure 12

The tire according to any one of Present Disclosures 1 to 11, wherein
the tread portion includes a first tread edge, a second tread edge, a plurality of circumferential grooves each extending continuously in the tire circumferential direction between the first tread edge and the second tread edge, and a plurality of land regions separated by the circumferential grooves,
the circumferential grooves include a first shoulder circumferential groove located closest to the first tread edge among the circumferential grooves and a first crown circumferential groove located between the first shoulder circumferential groove and the tire equator,
the land regions include a first middle land region demarcated between the first shoulder circumferential groove and the first crown circumferential groove, and
the first middle land region is the block row.

### Present Disclosure 13

The tire according to Present Disclosure 12, wherein
the axial grooves include a plurality of first middle axial grooves, and
the first shoulder circumferential groove has a groove wall having an angle with respect to a tire normal line thereof larger than an angle with respect to a tire normal line of a groove wall of each of the first middle axial grooves.

### Present Disclosure 14

The tire according to Present Disclosure 12 or 13, wherein
the blocks include a plurality of first middle blocks arranged in the first middle land region,
each of the first middle blocks is provided with a plurality of first middle axial sipes each extending in the tire axial direction from the first shoulder circumferential groove or the first crown circumferential groove, and
each of the first middle axial sipes terminates without communicating with the circumferential sipe in each of the first middle blocks.

### Present Disclosure 15

The tire according to any one of Present Disclosures 12 to 14, wherein
the tread portion position for mounting the tire on a vehicle is specified regarding inner and outer sides of the tread portion with respect to the vehicle, and
the first tread edge is located on the outer side of the vehicle when the tire is mounted on the vehicle.

### Present Disclosure 16

The tire according to Present Disclosure 7, wherein an angle between the sub-circumferential sipe and the portion of the circumferential sipe extending obliquely to the first side is in the range from 90 to 135 degrees.

### Present Disclosure 17

The tire according to Present Disclosure 10, wherein
the circumferential sipe has a sipe main body portion continuous with the chamfered portion on the radially inner side thereof, and
the width of the inclined surface is in the range from 1.0 to 1.5 mm and 50% or more of a width of the sipe main body portion in the plan view of the ground contact surface.

### Present Disclosure 18

The tire according to Present Disclosure 13, wherein
each of the first middle axial grooves consists of a first groove portion and a second groove portion,
the first groove portion communicates with the first shoulder circumferential groove and extends linearly and obliquely with respect to the tire axial direction, and
the second groove portion communicates with the first crown circumferential groove and extends linearly and obliquely to a side opposite to the first groove portion with respect to the tire axial direction.

### Present Disclosure 19

The tire according to Present Disclosure 13 or 18, wherein
the angle of the groove wall of the first shoulder circumferential groove with respect to the tire normal line is in the range from 10 to 15 degrees, and
the angle of the groove wall of each of the first middle axial grooves with respect to the tire normal line is in the range from 1 to 4 degrees.

### Present Disclosure 20

The tire according to Present Disclosure 14, wherein
the first middle axial sipes include outer first middle axial sipes and inner first middle axial sipes,
each of the outer first middle axial sipes communicates with the first shoulder circumferential groove and extends in a zigzag shape, and
each of the inner first middle axial sipes communicates with the first crown circumferential groove and extends in the tire axial direction linearly and obliquely with respect to the tire axial direction.

### DESCRIPTION OF REFERENCE SIGNS

2 tread portion
16 axial groove
17 block
27 circumferential sipe
28 bent portion
30 chamfered portion

1. A tire having a tread portion comprising:
a plurality of axial grooves;
a plurality of blocks separated by the plurality of axial grooves; and
a block row including the plurality of blocks,
wherein each of the blocks is provided with one circumferential sipe,
the circumferential sipe extends in the tire circumferential direction so as to communicate with at least one of the axial grooves and has one or more bent portions bent locally, and
at least one of edges of the circumferential sipe is provided with a chamfered portion.

2. The tire according to claim 1, wherein the chamfered portion is formed over the entire length of the circumferential sipe.

3. The tire according to claim 1, wherein each of the edges of the circumferential sipe on both sides thereof is provided with the chamfered portion.

4. The tire according to claim 1, wherein the circumferential sipe completely crosses the each of the blocks in the tire circumferential direction.

5. The tire according to claim 1, wherein
the circumferential sipe has a first end communicating with one of the axial grooves and a second end terminating within the each of the blocks to have a terminating end,
each of the blocks is provided with a sub-circumferential sipe,
the sub-circumferential sipe communicates with another one of the axial grooves located on a side opposite to the axial groove communicating with the first end of the circumferential sipe, and extends therefrom in the tire circumferential direction to terminate within the each of the blocks to have a terminating end, and
the shortest distance between the terminating end of the circumferential sipe and the terminating end of the sub-circumferential sipe is 2.0 mm or less.

6. The tire according to claim 5, wherein
the sub-circumferential sipe is provided with a chamfered portion, and
the chamfered portion of the sub-circumferential sipe is connected with the chamfered portion of the circumferential sipe.

7. The tire according to claim 5, wherein
the circumferential sipe includes a portion extending obliquely from the terminating end thereof to a first side with respect to the tire circumferential direction, and
the sub-circumferential sipe is inclined to a second side opposite to the first side with respect to the tire circumferential direction.

8. The tire according to claim 1, wherein the circumferential sipe has the maximum depth in the range from 50% to 100% of the maximum height of the each of the blocks.

9. The tire according to claim 1, wherein the circumferential sipe has a bending angle in the range from 90 to 135 degrees at the or each bent portion thereof.

10. The tire according to claim 1, wherein
in a cross section perpendicular to the longitudinal direction of the circumferential sipe, the chamfered portion includes an inclined surface extending obliquely with respect to a normal line of the tire from a ground contact surface of the each of the blocks, and
the inclined surface has a width in the range from 0.5 to 2.0 mm in a plan view of the ground contact surface.

11. The tire according to claim 1, wherein the chamfered portion has a chamfer depth in the range from 0.5 to 2.0 mm.

12. The tire according to claim 1, wherein
the tread portion includes a first tread edge, a second tread edge, a plurality of circumferential grooves each extending continuously in the tire circumferential direction between the first tread edge and the second tread edge, and a plurality of land regions separated by the circumferential grooves,
the circumferential grooves include a first shoulder circumferential groove located closest to the first tread edge among the circumferential grooves and a first crown circumferential groove located between the first shoulder circumferential groove and the tire equator,
the land regions include a first middle land region demarcated between the first shoulder circumferential groove and the first crown circumferential groove, and
the first middle land region is the block row.

13. The tire according to claim 12, wherein
the axial grooves include a plurality of first middle axial grooves, and
the first shoulder circumferential groove has a groove wall having an angle with respect to a tire normal line thereof larger than an angle with respect to a tire normal line of a groove wall of each of the first middle axial grooves.

14. The tire according to claim 12, wherein
the blocks include a plurality of first middle blocks arranged in the first middle land region,
each of the first middle blocks is provided with a plurality of first middle axial sipes each extending in the tire axial direction from the first shoulder circumferential groove or the first crown circumferential groove, and
each of the first middle axial sipes terminates without communicating with the circumferential sipe in each of the first middle blocks.

15. The tire according to claim 12, wherein
the tread portion position for mounting the tire on a vehicle is specified regarding inner and outer sides of the tread portion with respect to the vehicle, and
the first tread edge is located on the outer side of the vehicle when the tire is mounted on the vehicle.

16. The tire according to claim 7, wherein an angle between the sub-circumferential sipe and the portion of the circumferential sipe extending obliquely to the first side is in the range from 90 to 135 degrees.

17. The tire according to claim 10, wherein
the circumferential sipe has a sipe main body portion continuous with the chamfered portion on the radially inner side thereof, and
the width of the inclined surface is in the range from 1.0 to 1.5 mm and 50% or more of a width of the sipe main body portion in the plan view of the ground contact surface.

18. The tire according to claim 13, wherein
each of the first middle axial grooves consists of a first groove portion and a second groove portion,
the first groove portion communicates with the first shoulder circumferential groove and extends linearly and obliquely with respect to the tire axial direction, and
the second groove portion communicates with the first crown circumferential groove and extends linearly and obliquely to a side opposite to the first groove portion with respect to the tire axial direction.

19. The tire according to claim 13, wherein
the angle of the groove wall of the first shoulder circumferential groove with respect to the tire normal line is in the range from 10 to 15 degrees, and
the angle of the groove wall of each of the first middle axial grooves with respect to the tire normal line is in the range from 1 to 4 degrees.

20. The tire according to claim 14, wherein
the first middle axial sipes include outer first middle axial sipes and inner first middle axial sipes,
each of the outer first middle axial sipes communicates with the first shoulder circumferential groove and extends in a zigzag shape, and
each of the inner first middle axial sipes communicates with the first crown circumferential groove and extends in the tire axial direction linearly and obliquely with respect to the tire axial direction.
